(19) United States
(12) Patent Application Publication
(10) Pub. No.: US 2015/0033876 A1
(43) Pub. Date: Feb. 5, 2015

(54) DETERMINING A POSITION BY MEASURING FORCES

(71) Applicant: SIEMENS AKTIENGESELLSCHAFT, München (DE)

(72) Inventor: Uwe Krause, Pattensen (DE)

(21) Appl. No.: 14/384,340

(22) PCT Filed: Mar. 12, 2013
(86) PCT No.: PCT/EP2013/055009

§ 371 Date: Sep. 10, 2014

(30) Foreign Application Priority Data
Mar. 15, 2012 (DE) 10 2012 204 080.3

(51) Int. Cl. G01B 5/14; E05F 1/16; G01L 5/00

(52) U.S. Cl. CPC G01B 5/14; G01L 5/0057; E05F 1/16
USPC 73/862.61

(57) ABSTRACT

A device and a method determines the position of an object which can be moved in a linear manner. The device includes a contact unit coupled to the object such that the contact unit provides a force signal that is dependent on the position of the object; a force detecting unit for detecting the force signal provided by the contact unit; and an evaluating unit for evaluating the force signal detected by the force detecting unit. The position of the object is ascertained using an evaluation function during the evaluation process, the evaluation function describing a dependence of the force signal on the position of the object.

### CROSS REFERENCE TO RELATED APPLICATIONS

This application is the U.S. national stage of International Application No. PCT/EP2013/055009, filed Mar. 12, 2013 and claims the benefit thereof. The International Application claims the benefit of German Application No. 102012204080.8filed on Mar. 15, 2012, both applications are incorporated by reference herein in their entirety.

### BACKGROUND

Described below are an apparatus and a method for determining a position of an object which can be moved in a linear manner, in particular a sliding door or an elevator door.

Various such apparatuses and methods are already known.

For example, DE 10 2009 042 800 A1 discloses a system comprising a drive unit and a sensor, with which the position of an element moved by the drive unit can be determined. The sensor is a distance meter for measuring a distance between the sensor and the movable element, from which a position of the movable element is determined.

DE 10 2006 040 232 A1 discloses a door drive for an automatic door with a brushless electric motor and a control apparatus for controlling and/or regulating the electric motor. The control apparatus comprises an angle transmitter working on a magnetic principle for generating an angle signal proportionate to the angle of rotation of the motor.

DE 10 2007 060 343 A1 discloses a monitoring apparatus for monitoring the movement of a wing of a powered gate with a position detection device for detecting a position of the wing. The position detection device has a distance measuring device for measuring a distance of a wing region from a stationary region using wave transmission.

Known from the patent application bearing the reference 102011003399.8 is a method for determining a position of at least one element which can be moved by a drive belt of a drive unit. In this case the drive belt is stretched over a measurement interval with a predetermined force about a change in displacement. An effective length of the drive belt is determined from the measurement interval and the force, as well as from an elasticity module and a cross-section of the drive belt, and the position is determined from the effective length.

### SUMMARY

Described below are an alternative method and an alternative apparatus for determining a position of a linearly movable object.

An apparatus for determining a position of a linearly movable object includes a contact unit, which is coupled to the object such that it supplies a force signal dependent on the position of the object, a force detection unit for detecting the force signal supplied by the contact unit and an evaluation unit for evaluating the force signal detected by the force detection unit.

An apparatus of this type does not require any moving components which are prone to wear in the measurement system and therefore has the advantage of being particularly resistant to wear and of being reliable. Furthermore, the apparatus only requires energy when a position of the object is also read out, and is hence efficient as regards the energy requirement and energy consumption. Furthermore, the apparatus can essentially be disposed in a space through which the object travels, so that the apparatus advantageously requires hardly any additional space.

In a first embodiment the contact unit has a spring element which is coupled by a first end to the object and by a second end to the force detection unit, so that the length of the spring element depends on the position of the object. The force detection unit here detects a restoring force of the spring element as a force signal.

This configuration provides a very easily and inexpensively achievable embodiment.

In this embodiment the spring element is for example arranged such that it runs along the direction of movement of the object, or it is guided by way of a deflection apparatus.

Both alternatives advantageously enable a direction of the restoring force of the spring element to be fixed. This means that in particular an especially easily configured force detection unit can be used, since it does not need to be designed for changes of direction of the restoring force.

Alternatively, in the aforementioned embodiment the force detection unit is rotatably mounted or is designed to detect a direction-dependent force signal.

This means that using the force detection unit a restoring force can be detected whose direction changes during the movement of the object. This advantageously enables the object to be directly connected to the force detection unit, without having to fix the direction of the restoring force. The contact unit can in this variant of the embodiment hence may include only the spring element and is thus especially easy to configure.

In a second embodiment the contact unit has a mass which is coupled to the object by way of a cable. In this case the cable is guided by way of a deflection element, so that a force dependent on the position of the object acts on the deflection element, and the force detection unit detects the force acting on the deflection element as a force signal.

This embodiment has the advantage, compared to the first embodiment mentioned above, that no spring element is used, whose spring constant changes over time, so that the evaluation of the force signal need not be adjusted to the changing properties of the contact unit.

In a third embodiment the contact unit has a belt drive for driving the object and a connection unit coupled to the belt drive and the force detection unit.

In a fourth embodiment the contact unit has a tension spring coupled to the force detection unit, by which the object is moved.

In all embodiments, the contact unit can in each case include a drive unit of the object, i.e. a component which is already present in any case. This advantageously reduces the components additionally required to determine the position. For example, the spring element of the first embodiment or the mass and the cable of the second embodiment can be designed and arranged such that the spring force of the spring element or the weight force of the mass exert an effective force for moving the object.

In the method for determining a position of a linearly movable object using the apparatus described above, a force signal supplied by the contact unit is detected by the force detection unit and the force signal detected by the force detection unit is evaluated by the evaluation unit. In this case the position of the object is determined based on an evaluation function which describes a dependence of the force signal on a coordinate specifying the position of the object.

In the method the position of the object is thus determined based on an evaluation function which assigns a force signal to the position of the object. In this way a position of the object can be derived from the force signal during a power outage even after the object is moved manually.

The evaluation function may be determined experimentally.

This means the evaluation function can be reliably determined under real conditions.

In another embodiment of the method, test positions of the object are predefined and the force signal is continuously detected at the test positions and is compared to the values of the evaluation function for the test positions. The evaluation function is updated if its values at the test positions differ from the force signals detected for the test positions.

This advantageously enables the evaluation function to be adjusted to changing properties of the apparatus, for example to a changing spring constant of the spring element in the first embodiment of the apparatus.

Thanks to the continuous examination of the evaluation function at predefined positions of the object, necessary adjustments of the evaluation function can be reliably identified and in addition a change over time in the properties of the apparatus can be documented and analyzed.

### BRIEF DESCRIPTION OF THE DRAWINGS

The above-described characteristics, features and advantages, as well as the manner in which these are realized, will become more clearly and easily intelligible in connection with the following description of exemplary embodiments which are explained in more detail with reference to the drawings, in which:

FIG. 1A is a schematic side view of a first apparatus for determining a position of a sliding door in an open position of the sliding door,

FIG. 1B is a schematic side view of the apparatus illustrated in FIG. 1A in a closed position of the sliding door,

FIG. 1C is a graph of an evaluation function for determining a position of the sliding door using the apparatus illustrated in FIGS. 1A and 1B,

FIG. 2A is a schematic side view of a second apparatus for determining a position of a sliding door in an open position of the sliding door,

FIG. 2B is a schematic side view of the apparatus illustrated in FIG. 2A in a closed position of the sliding door,

FIG. 2C is a graph of an evaluation function for determining a position of the sliding door using the apparatus illustrated in FIGS. 2A and 2B,

FIG. 3A is a schematic side view of a third apparatus for determining a position of a sliding door in an open position of the sliding door,

FIG. 3B is a schematic side view of the apparatus illustrated in FIG. 3A in a closed position of the sliding door,

FIG. 3C is a graph of an evaluation function for determining a position of the sliding door using the apparatus illustrated in FIGS. 3A and 3B,

FIG. 4A is a schematic side view of a fourth apparatus for determining a position of a sliding door in an open position of the sliding door,

FIG. 4B is a schematic side view of the apparatus illustrated in FIG. 4A in a closed position of the sliding door, and

FIG. 4C is a graph of an evaluation function for determining a position of the sliding door using the apparatus illustrated in FIGS. 4A and 4B.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

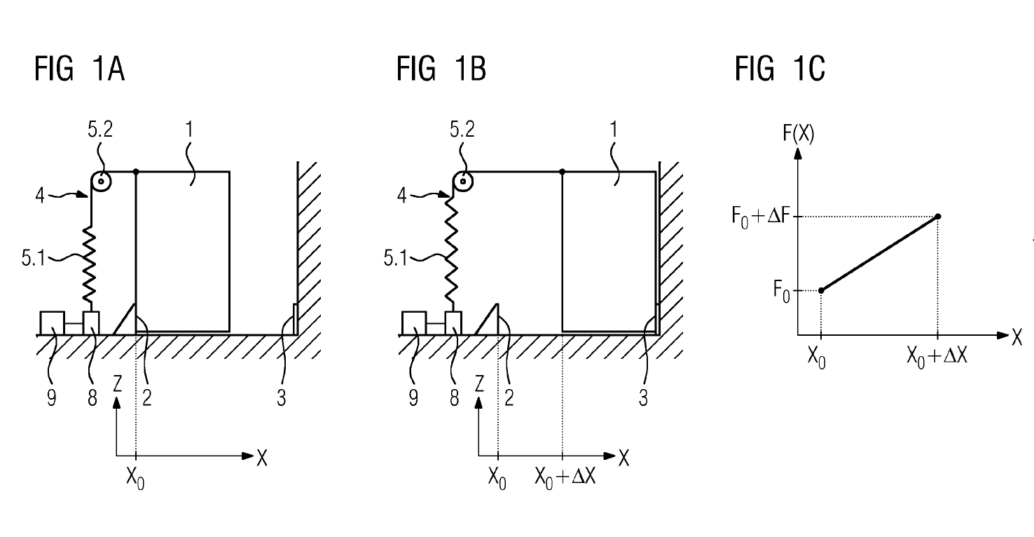

FIGS. 1A, 1B, 2A, 2B, 3A, 3B, 4A, 4B schematically show different apparatuses for determining a position of a linearly movable object 1, which in these exemplary embodiments is a sliding door which can be moved linearly between an open position illustrated in FIGS. 1A, 2A, 3A, 4A and a closed position illustrated in FIGS. 1B, 2B, 3B, 4B. The direction of movement of the sliding door here defines the X direction of a Cartesian coordinate system with coordinates X, Y, Z.

In the open position the sliding door hits a first stop 2. In the closed position the sliding door hits a second stop 3.

The various apparatuses for determining the position of the sliding door each has a contact unit 4 coupled to the sliding door and a force detection unit 8 coupled to the contact unit 4. The contact unit 4 is in each case coupled to the sliding door and the force detection unit 8 such that it supplies a force signal F dependent on the position of the sliding door. The force signal F is detected by the force detection unit 8. As a force detection unit 8 a suitable force sensor can be used here, for example a force sensor having an expansion measurement strip or a spring with potentiometric, incremental or magnetic force detection.

The force signal F detected by the force detection unit 8 is in each case passed to an evaluation unit 9, by which it is evaluated to determine the position of the sliding door. An evaluation function F(X) is used in each case for this purpose, which describes a dependence of the force signal F on the position of the sliding door.

The position of the sliding door is here specified by the X coordinate of the door edge of the sliding door which in the open position of the sliding door abuts against the first stop 2 (in FIGS. 1A, 1B, 2A, 2B, 3A, 3B, 4A, 4B this is the left door edge in each case). X₀ indicates the position of the sliding door in the open position. X₀+ΔX indicates the position of the sliding door in the closed position, i.e. ΔX is the distance between the closed sliding door and the first stop 2. F₀ designates the value F(X₀) of the evaluation function F(X) when the sliding door is open. F₀+ΔF designates the value F(X₀+ΔX) of the evaluation function F(X) when the sliding door is closed.

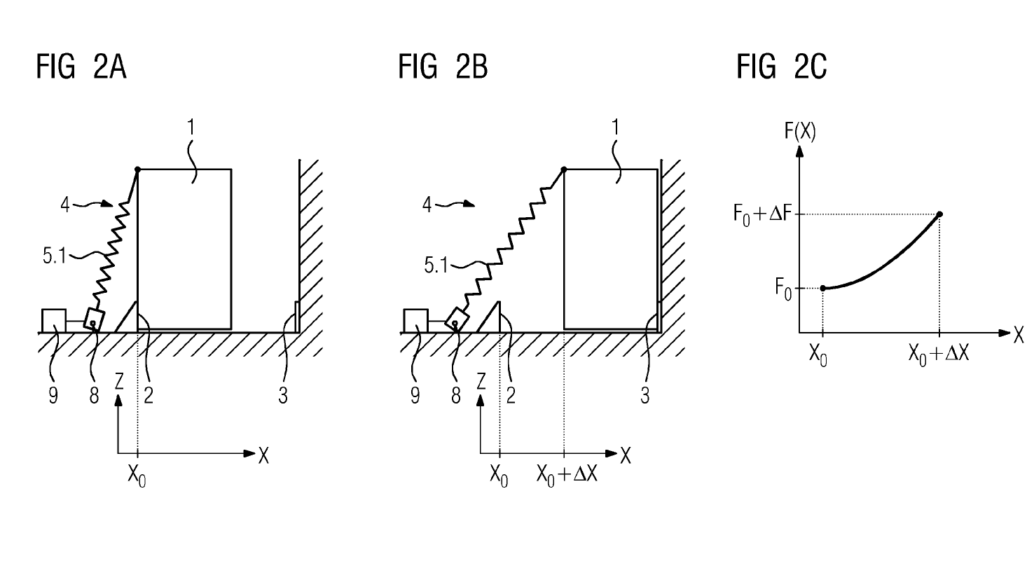

FIGS. 10, 2C, 3C, 4C schematically show evaluation functions F(X) for the apparatuses illustrated in FIGS. 1A, 1B, 2A, 2B, 3A, 3B, 4A, 4B.

In all exemplary embodiments illustrated, Fo is the minimum of the evaluation function F(X) in the interval [X₀,X₀+ΔX]. This can in particular be exploited to identify faults in the respective apparatus. If for example a detected force signal F is significantly smaller than F₀, this points to a defect in the apparatus.

The various apparatuses illustrated in the figures essentially differ in the formation of the contact unit 4 and the associated evaluation function F(X).

FIGS. 1A and 1B show an apparatus whose contact unit 4 has a spring element 5.1, for example a rubber cable, and a deflection apparatus 5.2 designed as a deflection roller. The spring element 5.1 is coupled by a first end to the sliding door and by a second end to the force detection unit 8. Here the spring element 5.1 is guided by way of the deflection apparatus 5.2 such that the spring element 5.1 runs between the sliding door and the deflection apparatus 5.2 in the X direction and between the deflection apparatus 5.2 and the force detection unit 8 in a Z direction perpendicular thereto.

During a movement of the sliding door from the open to the closed position the spring element 5.1 is stretched and supplies a restoring force dependent on the stretching as a force signal F. This force signal F is detected by the force detection unit 8.

In the exemplary embodiment illustrated in FIGS. 1 A and 1B a linear relationship between the length and the restoring force of the spring element 5.1 has been assumed in accordance with Hooke's law. Since in this exemplary embodiment the change in length of the spring element 5.1 is equal to the distance between the sliding door and the first stop 2, the evaluation function F(X) is likewise linear. In particular the evaluation function F(X) is hence monotonous and thus allows a position of the sliding door to be unambiguously assigned to a detected force signal F.

FIGS. 2A and 2B show an apparatus whose contact unit 4 includes only a spring element 5.1 which is coupled by a first end to the sliding door and by a second end to the force detection unit 8. Unlike the exemplary embodiments illustrated in FIGS. 1A and 1B, the spring element 5.1 in this case connects the sliding door and the force detection unit 8 directly to one another, without being guided by way of a deflection apparatus 5.2.

This simplifies the structure compared to the exemplary embodiment illustrated in FIGS. 1A and 1B.

However, the arrangement illustrated in FIGS. 2A and 2B requires the force detection unit 8 to be rotatably mounted or to be designed to detect a direction-dependent force signal F, since in this arrangement the angle between the spring element 5.1 and the X direction changes during the movement of the sliding door.

The change in angle also means that the associated evaluation function F(X) shown in FIG. 2C is not linear, even if the length and the restoring force of the spring element 5.1 depend on one another linearly in accordance with Hooke's law. Instead, the gradient of the evaluation function F(X) increases with X, so that the resolution of the evaluation of the force signal F improves toward the closed position of the sliding door. In this exemplary embodiment too the evaluation function F(X) is monotonous and thus allows a position of the sliding door to be unambiguously assigned to a detected force signal F.

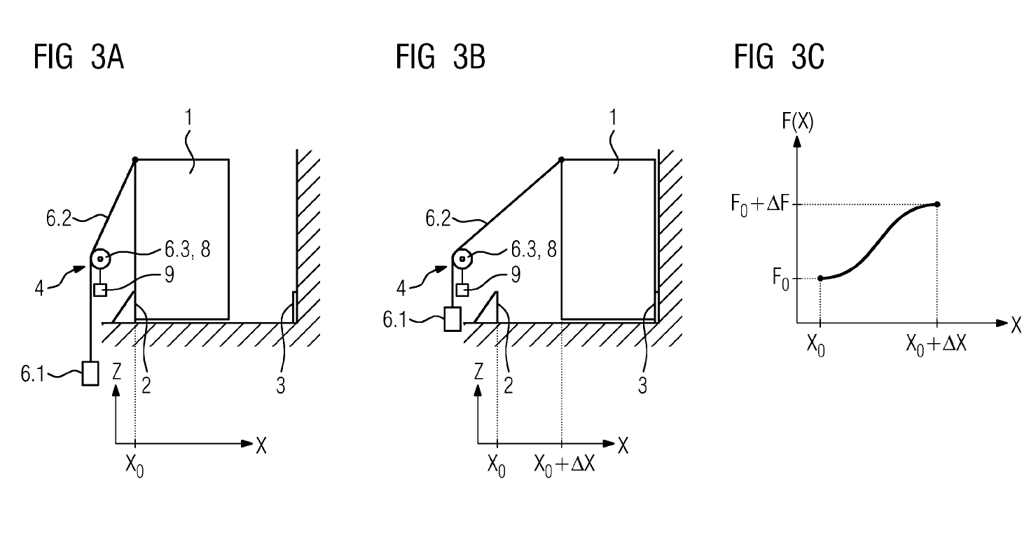

FIGS. 3A and 3B show an apparatus whose contact unit 4 has a mass 6.1, a cable 6.2 and a deflection apparatus 6.3. The mass 6.1 is coupled by way of the cable 6.2 to the sliding door and is guided by way of the deflection element 6.3 such that a force dependent on the position of the sliding door acts on the deflection element 6.3. The force detection unit 8 detects this force acting on the deflection element 6.3 as a force signal F. The direction and the extent of this force change during a movement of the sliding door, since the angle between the X direction and that between the sliding door and the deflection element 6.3 changes. In this exemplary embodiment too the force detection unit 8 is hence rotatably mounted or is designed to detect a direction-dependent force signal F.

FIG. 3C schematically shows the evaluation function F(X) of the apparatus illustrated in FIGS. 3A and 3B. In this exemplary embodiment too the evaluation function F(X) is monotonous.

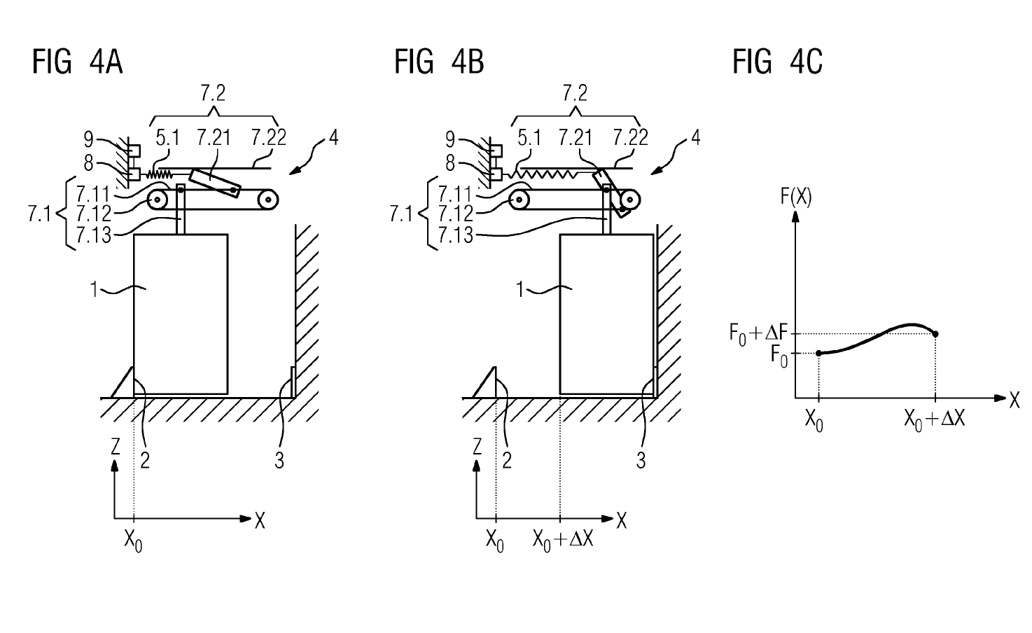

FIGS. 4A and 4B show an apparatus whose contact unit 4 has a belt drive 7.1 for driving the sliding door and a connection unit 7.2 coupled to the belt drive 7.1 and the force detection unit 8.

The belt drive 7.1 includes a drive belt 7.11, two belt pulleys 7.12 and a drive rod 7.13. The drive belt 7.11 runs by way of the belt pulleys 7.12 and is connected at one point to the drive rod 7.13, which in turn is connected to the sliding door.

The connection unit 7.2 includes a connection rod 7.21, a linear guide 7.22 and a spring element 5.1. The connection rod 7.21 is connected by a first end to the drive belt 7.11 and in this case is mounted such that it can rotate in the XZ plane. The second end of the connection rod 7.21 is guided along the X direction by the linear guide 7.22. The spring element 5.1 is coupled by one end to the second end of the connection rod 7.21 and by the other end to the force detection unit 8 and runs in the X direction. Instead of a separate linear guide 7.22 the second end of the connection rod 7.21 can also be guided along the X direction with the help of the drive belt 7.11.

The connection rod 7.21 is connected to the drive belt 7.11 such that the first end of the connection rod 7.21 moves during the movement of the sliding door from the open to the closed position initially from a position between the two belt pulleys 7.12 to one of the belt pulleys 7.12 and then, shortly before the closed position of the sliding door is reached, is guided around this belt pulley 7.12. This means the second end of the connection rod 7.21 reverses its direction of movement, shortly before the sliding door reaches the closed position.

During the movement of the sliding door from the open to the closed position the stretching of the spring element 5.1 accordingly increases initially and decreases again shortly before the closed position is reached. The force detection unit 8 detects the restoring force of the spring element 5.1 as a force signal F.

FIG. 4C schematically shows the resulting evaluation function F(X). Because the stretching of the spring element 5.1 decreases shortly before the closed position of the sliding door is reached, the evaluation function (F(X) is not monotonous in this exemplary embodiment. Because the force signal F decreases shortly before the closed position of the sliding door is reached it is possible to reliably identify that the closed position of the sliding door has been reached.

In all exemplary embodiments the force signal F can either be a pure measurement signal for determining a position or it can be generated by an effective force. In the first case the force should be as small as possible, in order not to exert any significant influence on the movement of the sliding door (e.g. F₀=1 N and F₀+ΔF=1.5 N). An effective force can for example be the spring force of a spring element 5.1 or the weight force of the mass 6.1, in order to enable or assist with opening of the sliding door. Similarly the effective force can be a spring or weight force which enables or assists with the closing of the sliding door.

Although the invention has been illustrated and described in greater detail on the basis of exemplary embodiments, the invention is not limited by the disclosed examples and other variations can be derived herefrom by the person skilled in the art without leaving the scope of protection of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-12. (canceled)

13. An apparatus for determining a position of an object which can be moved in a linear manner, comprising:
a contact unit, coupled to the object, generating a force signal dependent on the position of the object;
a force detection unit detecting the force signal supplied by the contact unit; and
an evaluation unit evaluating the force signal detected by the force detection unit.

14. The apparatus as claimed in claim 13,
wherein the contact unit comprises a spring element, coupled by a first end to the object and by a second end to the force detection unit, having a length dependent on the position of the object, and
wherein the force detection unit detects a restoring force of the spring element as the force signal.

15. The apparatus as claimed in claim 14, further comprising a deflection apparatus guiding the spring element.

16. The apparatus as claimed in claim 14, wherein the force detection unit is rotatably mounted.

17. The apparatus as claimed in claim 14, wherein the force detection unit detects a direction-dependent force signal.

18. The apparatus as claimed in claim 13,
further comprising:
a deflection element; and
a cable guided by the deflection element,
wherein the contact unit has a mass coupled to the object by the cable, and
wherein the force detection unit detects, as the force signal, a force acting on the deflection element that is dependent on the position of the object.

19. The apparatus as claimed in claim 13, wherein the contact unit comprises:
a belt drive driving the object; and
a connection unit coupled to the belt drive and the force detection unit.

20. The apparatus as claimed in claim 13, wherein the contact unit comprises a tension spring, coupled to the force detection unit, at least one of causing and assisting movement of the object.

21. The apparatus as claimed in claim 13, wherein the contact unit comprises a mass, coupled to the force detection unit, producing a weight force at least one of enabling and assisting movement of the object.

22. A method for determining a position of a linearly movable object, comprising
generating a force signal dependent on the position of the object by a contact unit coupled to the object;
detecting the force signal by a force detection unit; and
evaluating the force signal by an evaluation unit based on an evaluation function which describes a dependence of the force signal on a coordinate specifying the position of the object.

23. The method as claimed in claim 22, wherein the evaluation function is determined experimentally for the object and the contact unit.

24. The method as claimed in claim 23, further comprising
continuously detecting the force signal at predefined test positions;
comparing detected values of the force signal to values of the evaluation function at the predefined test positions; and
updating the evaluation function when the values of the evaluation function at the predefined test positions differ from the detected values of the force signal at the predefined test positions.

25. The method as claimed in claim 22, further comprising
continuously detecting the force signal at predefined test positions;
comparing detected values of the force signal to values of the evaluation function at the predefined test positions; and
updating the evaluation function when the values of the evaluation function at the predefined test positions differ from the detected values of the force signal at the predefined test positions.
